(19) United States
(12) Patent Application Publication
(10) Pub. No.: US 2016/0268037 A1
(43) Pub. Date: Sep. 15, 2016

(54) Stationary Induction Electric Apparatus and Method for Making the Same

(71) Applicant: Hitachi, Ltd., Tokyo (JP)

(72) Inventors: Akira NISHIMIZU, Tokyo (JP); Naoya MIYAMOTO, Tokyo (JP); Akira YAMAGISHI, Tokyo (JP); Kazuhiro KAMIMURA, Tokyo (JP)

(21) Appl. No.: 15/060,654

(22) Filed: Mar. 4, 2016

(30) Foreign Application Priority Data
Mar. 10, 2015 (JP) 2015-046624

(51) Int. Cl. H01F 27/28; H01F 27/24; H01F 41/04; H01F 27/02

(52) U.S. Cl. CPC H01F 27/28; H01F 27/02; H01F 27/24; H01F 41/04

(57) ABSTRACT

There is provided a stationary induction electric apparatus including a core; a disk winding wound around the core; and a tank having the core and the disk winding inside. The disk winding is configured by stacking a plurality of pancake windings wound to pile in the radius direction of the core and connecting ends of the plurality of pancake windings to each other.

### BACKGROUND OF THE INVENTION

1. Field of the Invention

The present invention relates to a stationary induction electric apparatus and a method for making the same. Specifically, the invention relates to a stationary induction electric apparatus such as a transformer and a core reactor having a disk winding, and a method for making the same.

2. Background Art

As a stationary induction electric apparatus, there is a transformer changing a voltage by a reactor adjusting impedance or magnetic coupling using an operation of a magnetic field. The transformer is a product roughly configured of a core and winding. Winding is designed so that a desired loss is obtained by dimensions and a method for winding of an element wire.

A mechanical force of winding is one of design specifications. An electromagnetic mechanical force of winding is an electromagnetic force generated by a current and the magnetic field of winding. Winding is required to be designed such that the impedance does not exceed a change amount of a target, even if an excessive current flows. In the design, the design of the winding strength is performed in consideration of the generation of the electromagnetic mechanical force.

Although winding of the transformer has a variety of structures, there are two patterns of cylindrical and disk windings roughly. Each structure will be described briefly.

Cylindrical winding has a structure illustrated in FIG. 3. It is a structure obtained by winding an element wire 3 in an axial direction 2 of a core and stacking winding layers in a radius direction 4 of the core. A duct for ensuring a space (oil path), through which oil flows, is disposed, in each winding layer.

On the other hand, a disk winding has a structure illustrated in FIG. 4. It is a structure obtained by winding an element wire in the radius direction 4 of a core, and stacking the winding layers in the axial direction 2. In winding in the radius direction 4, a winding operation for a winding layer 9 stacked over an initial winding layer 8 in the axial direction 2 of a core is performed in a direction from the outer periphery to the inner periphery, and thus the winding operation takes time.

As features according to the comparison of both, in the cylindrical winding, manufacturing is simple and costs are low, but strength against the electromagnetic mechanical force is low. In the disk winding, costs are high, but the strength against the electromagnetic mechanical force is high. Thus, in a large transformer, in which a large electromagnetic mechanical force is generated, the disk winding is generally used.

For the disk winding, as illustrated in JP-B-7-54774, a winding structure, in which winding order of winding is adjusted for the purpose of proper voltage distribution in the winding, is known. In order to achieve the winding structure, 4 or more sections of the winding are wound as a pair and the winding is formed by connecting the pair.

### SUMMARY OF THE INVENTION

However, in the invention described in JP-B-7-54774, as described above, in the winding in the radius direction, there is a problem that it takes time in the winding operation in a direction from the outer periphery to the inner periphery. Thus, an object of the invention is to provide a stationary induction electric apparatus using a disk winding and a method for making the same in which an operation time is decreased and cost is thereby reduced, by omitting the winding operation in a direction from the outer periphery to the inner periphery.

According to an aspect of the present invention, there is provided a stationary induction electric apparatus including a core; a disk winding wound around the core; and a tank having the core and the disk winding inside, in which the disk winding is configured by stacking a plurality of pancake windings wound to pile in the radius direction around the core and connecting ends of the plurality of pancake windings to each other.

According to the invention, when manufacturing the disk winding of a stationary induction electric apparatus, a winding operation in a direction from the outer periphery to the inner periphery in the radius direction around the core becomes unnecessary and a winding manufacturing time can be shortened. Thus, it is possible to provide the stationary induction electric apparatus at a low cost.

### BRIEF DESCRIPTION OF THE DRAWINGS

FIG. 1 is an explanatory view illustrating an embodiment of the invention.

FIG. 2 is an explanatory view illustrating another embodiment of the invention.

FIG. 3 is an explanatory view of a cylindrical coil.

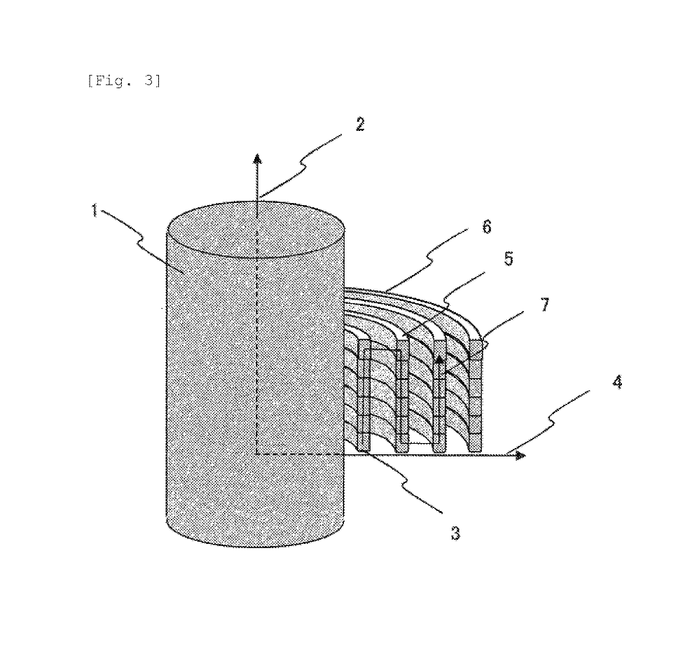

FIG. 4 is an explanatory view of a disk coil.

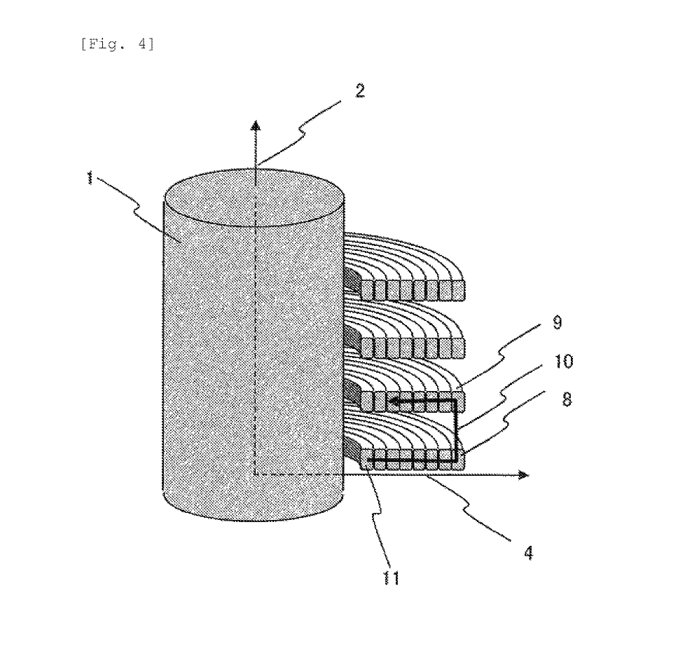

### DETAILED DESCRIPTION OF THE INVENTION

Hereinafter, Example of the invention will be described with reference to the drawings. Moreover, a core 1 and a disk winding wound around the core 1 illustrated in the drawings are all sealed within a tank and configure a stationary induction apparatus such as a transformer and a core reactor. In the drawings, for the sake of simplicity, only the core and the disk winding wound around the core are illustrated and the tank and other configurations are omitted.

### Embodiment 1

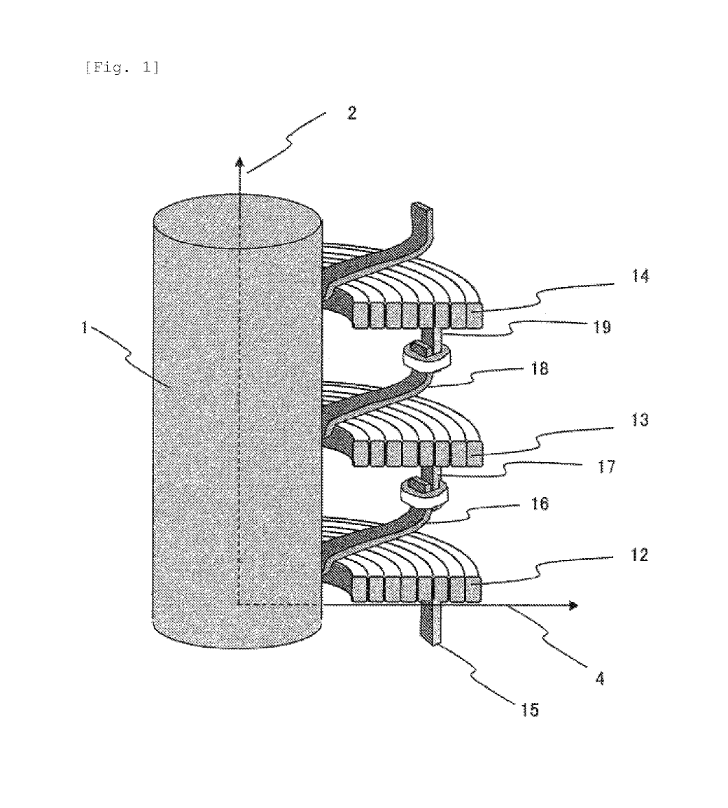

A first embodiment of the invention will be described with reference to FIG. 1

A factor of an increase in a manufacturing time of a disk winding is a winding operation in a direction from the outer periphery to the inner periphery. In order to configure the winding without executing the operation, a stationary induction electric apparatus of the invention is configured by manufacturing a plurality of pancake windings individually and connecting the plurality of the pancake windings to each other.

A specific structure is illustrated in FIG. 1. A disk winding of the invention is configured of a plurality of pancake windings 12, 13, and 14, and the like. For the sake of simplicity, pancake windings exceeding the amount of three are not illustrated. The pancake windings 12, 13, and 14 have a structure obtained by simply winding an element wire in the radius direction. When taking the pancake winding 12 as an example, an end line-winding 15 and a start line-winding 16 are configured to be pulled out the winding.

The plurality of such pancake windings 12, 13, and 14 are formed and are stacked such that the total number of windings becomes a predetermined number of windings. When stacking the pancake windings, a holding unit of an axis position such as an insulating cylinder and the like is used so that the axis is not shifted.

Another pancake winding 13 adjacent to one pancake winding 12 is stacked. The start line-winding 16 of the pancake winding and an end line-winding 17 of the pancake winding 13 of a second layer are connected. Next, an end line-winding 19 of the pancake winding 14 of a third layer and a start line-winding 18 of the pancake winding 13 of the second layer are connected. The winding is configured by repeating the operation so as to become a desired winding. Since each pancake winding is formed individually and all of the windings are configured by connecting the pancake windings, it is possible to omit the winding operation from the outer periphery to the inner periphery around the core that is performed in the related art and takes time.

Caulking, heat-sealing, brazing, and the like are performed in the connection. In addition, as a modification example, for example, it is also possible to arrange the pancake winding 12 upside down. In this case, the end line-winding 15 of the pancake winding 12 and the end line-winding 17 of the pancake winding 13 of the second layer are connected. The connection may be performed such that directions of currents flowing through the element wires are the same as each other when viewed from a cross section of the winding.

In consideration of workability, it is preferable that the connection between the pancake windings is performed on an outer periphery side of each pancake winding, but in a case where structures other than the winding are in the vicinity of the outer periphery side of the pancake winding and an operation space cannot be sufficiently ensured, the connection is performed on an inside thereof.

In addition, as a modification example, connection may be performed other than the pancake windings adjacent to each other. For example, the pancake winding 12 may be connected to the pancake winding 14 and the pancake winding 14 may be connected to the pancake winding 13.

After disposing the pancake winding of the first layer, in order to provide a passage (hereinafter, referred to as an “oil path”) of insulating oil sealed within the tank in the disk winding, an oil path forming unit is disposed between the pancake windings and the pancake winding of the second layer may be disposed. As the oil path forming unit, an insulating paper adhered to a duct may be used or the duct may be directly attached.

In addition, the pancake windings may be configured by integrating the element wires with each other. Specifically, the integration is performed by application of varnish, connection of a plurality of the pancake windings, and the like.

According to the embodiment configured as described above, the winding operation of the disk winding in the direction from the outer periphery to the inner periphery in the radius direction around the core becomes unnecessary and the winding manufacturing time can be shortened. Thus, it is possible to provide the stationary induction electric apparatus at a low cost.

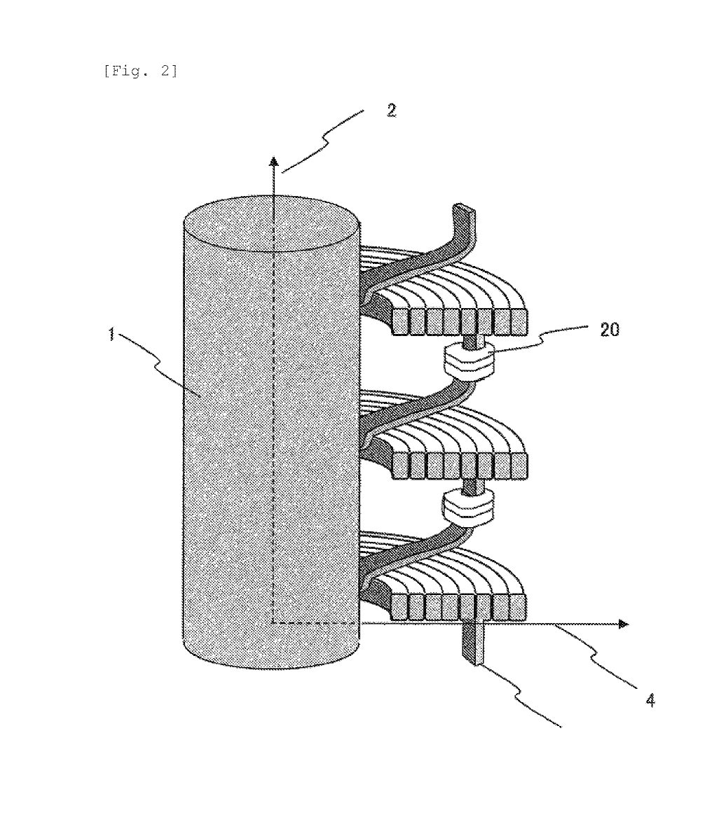

Next, another embodiment is illustrated in FIG. 2. This is an example in which an insulating process is performed in a connection portion. In order to increase insulating strength, insulating papers 20 are wound around the connection portions and it is possible to improve the insulating strength.

What is claimed is:

1. A stationary induction electric apparatus comprising:
a core;
a disk winding wound around the core; and
a tank having the core and the disk winding inside,
wherein the disk winding is configured by stacking a plurality of pancake windings wound to pile in a radius direction around the core and connecting ends of the plurality of pancake windings to each other.

2. The stationary induction electric apparatus according to claim 1,
wherein ends of the adjacent pancake windings are connected to each other.

3. The stationary induction electric apparatus according to claim 1,
wherein a start line-winding and an end line-winding of each the pancake windings are connected, and insulating papers are wound around the connected portions.

4. The stationary induction electric apparatus according to claim 2,
wherein a start line-winding and an end line-winding of each of the pancake windings are connected, and insulating papers are wound around the connected portions.

5. A method for making a stationary induction electric apparatus including a core, a disk winding wound around the core, and a tank having the core and the disk winding inside, the method comprising:
stacking a plurality of pancake windings wound to pile in the radius direction around the core; and
connecting ends of the plurality of pancake windings to each other.
